(19) United States
(12) Patent Application Publication
(10) Pub. No.: US 2004/0237708 A1
(43) Pub. Date: Dec. 2, 2004

(54) Pedal crank drive mechanism for a bicycle

(76) Inventor: Gerhard Hilber, St. Johann in Tirol (AT)

Correspondence Address: Collard & Roe, 1077 Northern Boulevard, Roslyn, NY, 11576, US

(21) Appl. No.: 10/481,946

(22) PCT Filed: Jun. 26, 2002
(86) PCT No.: PCT/AT02/00186

(30) Foreign Application Priority Data
Jun. 26, 2001 (AT) 980/01

(51) Int. Cl. G05G 1/14

(52) U.S. Cl. 74/594.2

(57) ABSTRACT

A pedal crank drive for a bicycle is described with two pedal cranks (2) which are torsionally rigidly connected with each other via a bottom bracket axle (1), comprising a chainwheel (3) which is held in a rotatable manner and is limited on a stop on a bearing nose (5) of one of the two pedal cranks (2) and at least one compression spring (12) extending in the circumferential direction between said pedal crank (2) and the chainwheel (3) bearing an abutment (14) for the compression spring (12). In order to provide advantageous constructional conditions it is proposed that the pedal crank (2) carrying the chainwheel (3) engages with a nose (16) which projects against the chainwheel (3) in a recess (17) of the chainwheel (3) which forms rotation limit stops (18, 19) for said pedal crank (2) in both circumferential directions.

### FIELD OF THE INVENTION

The invention relates to a pedal crank drive for a bicycle with two pedal cranks which are torsionally rigidly connected with each other via a bottom bracket axle, comprising a chainwheel which is held in a rotatable manner and is limited on a stop on a bearing nose of one of the pedal cranks and a compression spring extending in the circumferential direction between said pedal crank and the chainwheel bearing an abutment for the compression spring.

### DESCRIPTION OF THE PRIOR ART

In order to achieve an advantageous distribution of torque over a rotation of a pedal crank drive for a bicycle it is known (EP 0 546 004 B1) to rotatably hold the chainwheel on an axial bearing nose of a pedal crank and to support the same via a compression spring on said pedal crank, so that the compression spring is tensioned during the downward pedaling via the pedal crank which moves ahead of the chainwheel and relaxes in the dead center range of the pedal crank drive under a respective transmission of torque onto the chainwheel. Since with the increasing load of the compression spring the supporting moment which must be exerted by a cyclist and prevents the return rotation of the pedal crank also becomes higher, a considerable delay in the pedal crank movement can occur during the relaxation of the compression spring in the dead center range. To ensure that the compression spring for the power transmission between pedal crank and chainwheel cannot suddenly relax due to a lack of supporting moment by the cyclist, the relaxation of the power transmission spring is delayed by a damping spring, so that sufficiently strong compression springs can be used without having to fear any impairment of the even rotating drive. The disadvantage in such known pedal crank drives is that as a result of the additional damping spring not only the constructional efforts but also the weight are increased.

It is further known (FR 2 409 183 A1) to extend the pedal crank via the bottom bracket axle into a two-arm lever which is drivably connected via two tension springs which are diametrically opposite with respect to the bottom bracket axle and are drivably connected with a chainwheel which is rotatably held on the bottom bracket axle. Since the tension springs cannot absorb the occurring forces within a permissible angle of rotation between the pedal crank and the chainwheel, a bracket is provided on the chainwheel which encompasses the pedal crank, which bracket allows through setting screws a setting of the spring pretension on the one hand and the angle of rotation on the other hand. The additional bracket leads to an increased constructional effort which is linked to additional weight and requires an eccentric application of force, which leads to very unfavorable stresses for the bearing of the chainwheel. Moreover, only comparably small forces can be stored for an even distribution of torque over a rotation of the pedal crank drive as a result of the tension springs.

### SUMMARY OF THE INVENTION

The invention is thus based on the object of providing a pedal crank drive for a bicycle of the kind mentioned above with simple constructional means in such a way that the advantages of a pressurizable power transmission spring between the pedal crank and the chainwheel which is rotatably held on the chainwheel can be utilized for a more even torque distribution over a pedal crank rotation without using additional damping springs.

The invention achieves the object in such a way that the pedal crank carrying the chainwheel engages with a nose which projects against the chainwheel in a recess of the chainwheel which forms rotation limit stops for said pedal crank in both circumferential directions.

Since as a result of this measure the possible torsion of the pedal crank relative to the chainwheel is limited by stops, the travel of the compression spring is limited during its relaxation, which in the case of a respective angular adjustment will lead to the consequence that the compression spring will relax in an rotational angle range of the pedal crank in which a sufficient supporting moment can still be applied by the cyclist in order to prevent any noticeable delay in the pedal crank movement. The relaxation of the compression spring thus ends before a return kick of the pedal crank drive needs to be feared. The delimitation of the necessary rotational angle of the chainwheel with respect to the pedal crank not only entails the desired event rotational drive, it also offers the possibility to use such pedal crank drives with back pedal brakes. Moreover, the stop-limited, spring-loaded initial position of chainwheel with respect to the pedal crank allows a simple setting of the pretension of the compression spring. The constructional solution of the mutual rotational limitation of the chainwheel and pedal crank does not require any special additional effort because it is merely necessary to provide on the pedal crank a nose projecting towards the chainwheel and a recess on the chainwheel into which the nose engages with play in the circumferential direction. This play determines the possible rotational angle between chainwheel and pedal crank which should not exceed 10° and will preferably lie between 7° and 9°. The nose projecting towards the chainwheel also allows in the stop position an application of force in the zone of the central plane of the bearing for the chainwheel, which leads to favorable bearing loads.

The compression spring which is disposed laterally next to the chainwheel and extends in the circumferential direction and finds its abutment on the chainwheel side preferably in a holding bracket which can be screwed onto the chainwheel produces a tilting moment on the chainwheel about an axis extending transversally to its axis of rotation. In order to advantageously remove said tilting moments which can become relatively high especially while cycling up mountains, the chainwheel can be held on the bearing nose of the pedal crank with the help of two needle roller bearings which are provided with conical bearing races and are mounted with oppositely opening angles of taper. As a result of the conical bearing races it is possible to receive both radial as well as axial chainwheel loads, namely despite the limited space between the bearing nose of the pedal crank and the hub of the chainwheel, which is only enabled by using rolling bodies in the form of needles.

In order to reduce the constructional efforts in connection with the installation of such needle roller bearings, the pedal crank carrying the chainwheel can be extended via the bottom bracket axle into a two-arm lever, with two compression springs being provided between the pedal crank and the chainwheel, which compression springs are each supported on a lever arm of the lever and are diametrically opposite with respect to the bottom bracket axle. As a result of this division into two rotationally symmetrical compression springs it is possible to compensate the occurring tilting moments, which allows using conventional rolling bearings for bearing the chainwheel, since in the rotational limitation as caused by the limit stop the application of force on the chainwheel via the nose of the pedal crank projecting against the chainwheel occurs under advantageous load conditions. Particularly simple constructional conditions are obtained in this connection when the hub of the chainwheel which receives at least one chainwheel in an exchangeable way is provided with integrally attached abutments for the two compression springs, thus ensuring a comparably low weight without endangering the required strength.

### BRIEF DESCRIPTION OF THE DRAWING

The object of the invention is shown in closer detail in an exemplary way, wherein:

FIG. 1 shows a pedal crank drive in accordance with the invention for a bicycle in a simplified side view;

FIG. 2 shows the chainwheel of the associated pedal crank removed from the bottom bracket axle in a view of the inner side;

FIG. 3 shows an axial sectional view through the chainwheel held on the pedal crank in the zone of its bearing on an enlarged scale, and

FIG. 4 shows a view corresponding to FIG. 1 of a constructional variant of a pedal crank drive in accordance with the invention.

### DESCRIPTION OF THE PREFERRED EMBODIMENTS

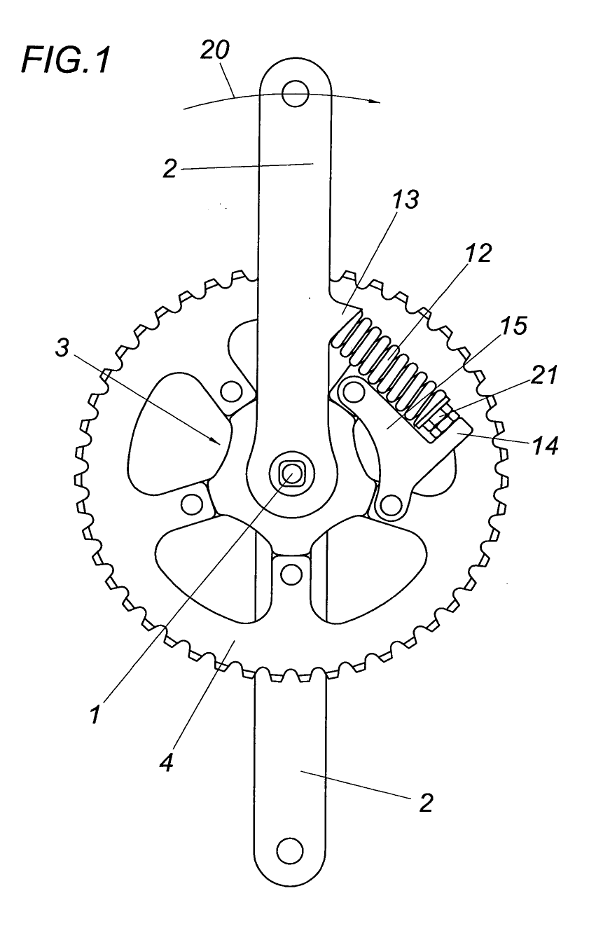

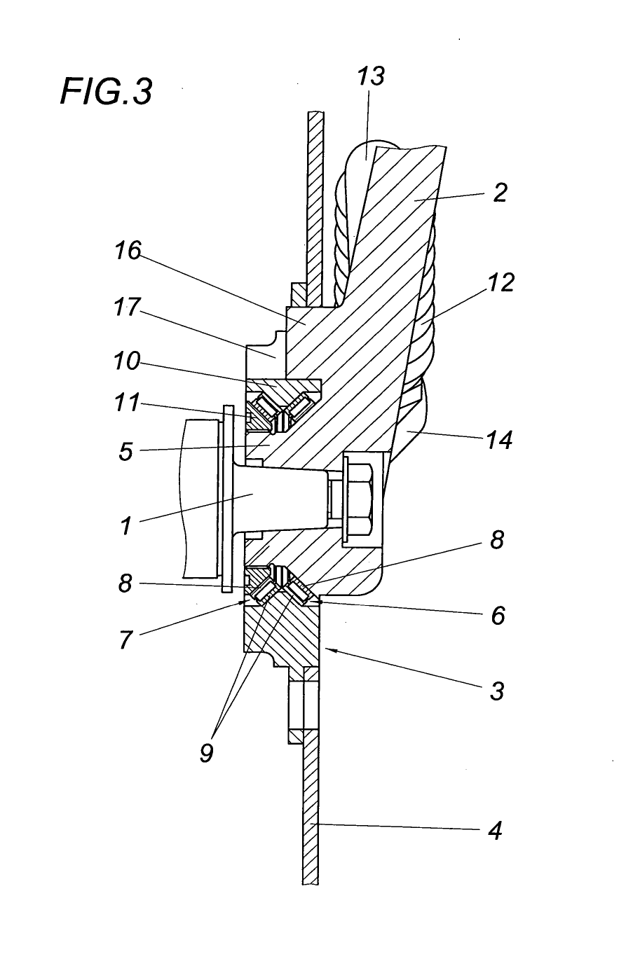

The pedal crank drive according to the embodiment in accordance with FIGS. 1 to 3 essentially consists of a bottom bracket axle 1 which is rotatably held in a bearing of a bicycle frame and carries two pedal cranks 2 which are provided in the usual manner with pedals, as well as a chainwheel 3 to which at least one toothed ring 4 is fastened. The chainwheel 3 is not torsionally rigidly connected with the bottom bracket axle 1 in the conventional manner, but is rotatably held on one of the bearing noses 5 of the one pedal crank 2. Said chainwheel bearing is provided through two needle roller bearings 6 and 7 with conical bearing races 8 and 9. As is shown in FIG. 3, said needle roller bearings 6 and 7 are installed in such a way that the angles of taper of the bearing races 8 and 9 open in a mutually opposite way. Whereas the outer bearing races 9 of the two needle roller bearings 6 and 7 rest on respective conical shoulders of the hub 10 of the chainwheel 3, the inner raceway 8 of the needle roller bearing 6 rests on a conical contact surface of the chainwheel hub 10. The two needle roller bearings 6 and 7 are tensioned in a play-free manner via the inner raceway 8 of the needle roller bearing 7, namely with the help of a conical nut 11 which is screwed onto the axial nose 5 of the pedal crank 2. As a result of this measure, the chainwheel 10 is supported in a play-free manner both in the axial as well as radial direction on the pedal crank 2.

A compression spring 12 is used for the power transmission between the pedal crank 2 and the chainwheel 3 which is held on said pedal crank 2, which compression spring 12 rests on the supporting nose 13 of the pedal crank 2 as well as the abutment 14 which is formed by a holding bracket 15. Said holding bracket 15 is screwed according to FIG. 1 to chainwheel 3 together with the toothed ring 4.

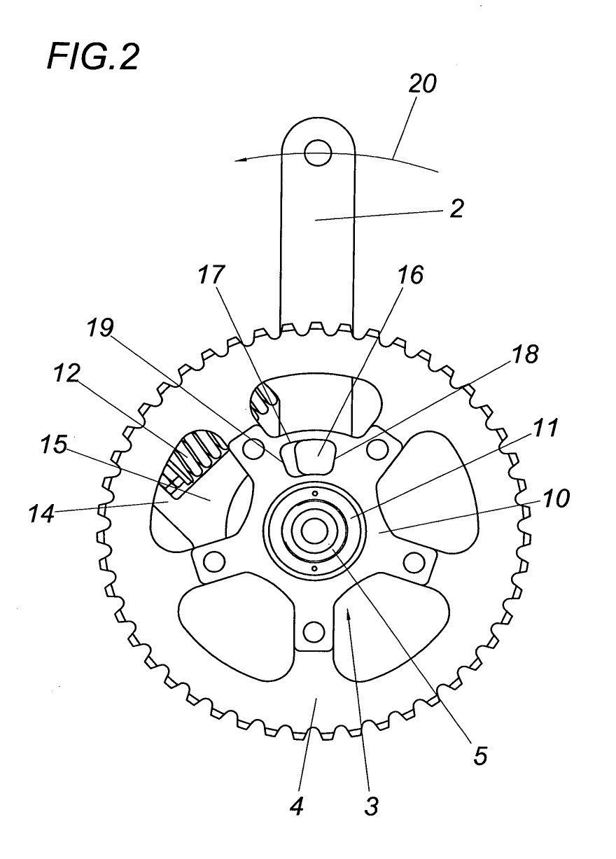

The pedal crank 2 is provided with a nose 16 which projects towards the chainwheel 3 and engages in a recess 17 of the chainwheel 3. As is shown in FIG. 2, the nose 16 of the pedal crank 2 is held with play in the recess 17 in the circumferential direction, so that the radial delimitations of the recess 17 lead to rotational limit stops 18 and 19 for the pedal crank 2 in both circumferential directions. The pedal crank 2 is thus pressed against the rotational limit stop 18 via the compression spring 12 against the direction of rotation 20 for the forward drive. With respect to said rotational limit stop 18 it is thus also possible to set the pretension of the compression spring 12 via an actuator 21. Moreover, the nose 16 penetrating the recess 17 leads to an application of force on the chainwheel 3 which extends in the zone of the central bearing plane with respect to the bearing of the chainwheel 3, so that favorable load conditions are obtained for the chainwheel bearing in the limit stop position of the nose 16.

If the compression spring 12 is tensioned via the pedal cranks 2 advancing the chainwheel 3 in the sense of direction 20, it will relax on decreasing the pedal crank loads in the dead center zone of the pedal crank drive with the effect that the then released spring force will be used for driving the chainwheel 3 when the cyclist can apply a sufficient supporting moment via the pedal cranks 2. This is ensured by the delimitation of rotation of the pedal cranks 2 with respect to the chainwheel 3 because the advancing movement of the chainwheel 3 in connection with the relaxation of the compression spring 12 is delimited with respect to the pedal cranks 2 by the rotational limit stop 18 before the supporting moment applied by the cyclist allows a delay of the pedal crank drive which would impair an even tread. This means that the compression spring 12 may not be compressed at will, which is ensured by the rotational limit stop 19. As has been seen in practice, the angle of rotation of the pedal crank 2 must not be larger than 10° between the rotational limit stops 18 and 19, so that the desired even rotation of the pedal crank drive can be ensured without using a damping spring delaying the relaxation of the compression spring 12. Since a considerable tilting moment can be exerted during the tensioning of the compression spring 12 on the chainwheel 3 due to the one-sided application of force by the compression spring 12, it is necessary to ensure a respective support of the chainwheel 3 both in the axial as well as the radial direction, which is achieved by the chosen bearing with the help of the needle roller bearings 6 and 7 with conical bearing races 8 and 9 without any particular constructional efforts.

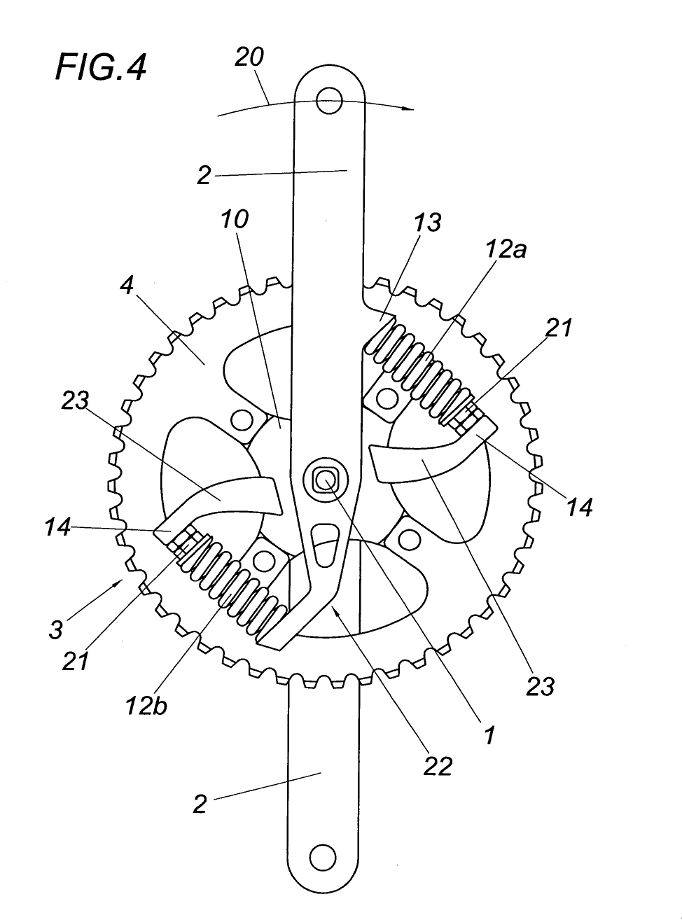

The pedal crank drive according to FIG. 4 can make do without such needle bearings because the compression spring 12 according to FIG. 1 is replaced by two compression springs 12a, 12b which are arranged in a rotationally symmetrical way. For this purpose the pedal crank 2 is extended via the pedal crank shaft 1 into a two-arm lever 22, so that the compression springs 12a, 12b can rest on the two arms of said two-arm lever 22. The abutments 14 for the compression springs 12a, 12b in the zone of the chainwheel 3 are formed by the noses 23 which are integrally arranged on the hub 10 of the chainwheel 3. The hub 10 carries one or several toothed rings 4 which are exchangeable in the conventional manner. By using two compression springs 12a, 12b, the tilting moments that occur otherwise by the spring arrangement on one side are prevented, which allows using conventional roller bearings for bearing the chainwheel 3. The two compression springs 12a, 12b hardly lead to any major weight loads because the two compression springs can be dimensioned in a weaker way and the attached noses 23 of the hub 10 of the chainwheel 3 represent a smaller weight load in comparison to the bracket 15 according to FIG. 1. The function of the pedal crank drive is not affected by this division into two compression springs 12a, 12b as compared with the arrangement according to FIGS. 1 to 3.

1. A pedal crank drive for a bicycle with two pedal cranks (2) which are torsionally rigidly connected with each other via a bottom bracket axle (1), comprising a chainwheel (3) which is held in a rotatable manner and is limited on a stop on a bearing nose (5) of one of the two pedal cranks (2) and at least one compression spring (12) extending in the circumferential direction between said pedal crank (2) and the chainwheel (3) bearing an abutment (14) for the compression spring (12), characterized in that the pedal crank (2) carrying the chainwheel (3) engages with a nose (16) which projects against the chainwheel (3) in a recess (17) of the chainwheel (3) which forms rotation limit stops (18, 19) for said pedal crank (2) in both circumferential directions.

2. A pedal crank drive as claimed in claim 1, characterized in that the chainwheel (3) can be held on the bearing nose (5) of the pedal crank (2) with the help of two needle roller bearings (6, 7) which are provided with conical bearing races (8, 9) and are mounted with oppositely opening angles of taper.

3. A pedal crank drive as claimed in claim 1, characterized in that the pedal crank (2) carrying the chainwheel (3) can be extended via the bottom bracket axle (1) into a two-arm lever (22) and that two compression springs (12a, 12b) are provided between the pedal crank (2) and the chainwheel (3), which compression springs (12a, 12b) are each supported on a lever arm of the lever (22) and are diametrically opposite each other with respect to the bottom bracket axle (1).

4. A pedal crank drive as claimed in claim 3, characterized in that the hub (10) which exchangeably receives at least one toothed ring (4) of the chainwheel (3) comprises integrally attached abutments (14) for the two compression springs (12a, 12b).
